(19) United States
(12) Patent Application Publication
(10) Pub. No.: US 2003/0208385 A1
(43) Pub. Date: Nov. 6, 2003

(54) System and method for underwriting insurance

(75) Inventors: Susan L. Zander, Westminster, CO (US); Adela de Loizaga Carney, Littleton, CO (US); Curtis D. Rullestad, Denver, CO (US); Martha M. Meyer, Indian Hills, CO (US); Nathan A. Johnson, Highlands Ranch, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ING North America Insurance Corporation, Atlanta, GA

(21) Appl. No.: 10/138,768

(22) Filed: May 3, 2002

(51) Int. Cl. G06F 17/60; G09G 5/00

(52) U.S. Cl. 705/4; 345/700

(57) ABSTRACT

A system used by a underwriter for evaluating life insurance applications. The system provides graphical user interfaces (screens) that are used to select conditions applicable to the insurance applicant, and to select ratings associated with those conditions. The ratings can be manually entered by an underwriter or entered automatically when selected at a screen. Ratings are displayed individually and as a total rating. The ratings may be manually adjusted by the underwriter. The system automatically calculates (using a mortality table) the life expectancy of the applicant based the total rating, and the life expectancy is recalculated when a rating is adjusted by the underwriter. The life expectancy is displayed side-by-side to ratings information on the screens so that the underwriter can visually determine the impact of ratings and adjustments to ratings on the life expectancy of the applicant. Profile screens may be used to prompt the underwriter to enter information concerning complex medical conditions (such as coronary artery disease or diabetes) and to automatically provide a rating from a rating table in response to the entered data.

### BACKGROUND OF THE INVENTION

The present invention relates to evaluating the insurability of risk and more particularly to a computer-based system, method and user interface for facilitating the underwriting of insurance, such as life insurance.

The use of computers to underwrite life insurance is known. In many cases, the underwriting of life insurance, even without the use of a computer, can be relatively straightforward. It might involve, for a healthy insurance applicant, the collection of a small amount of information (age, smoker v. non-smoker, height and weight, gender) and perhaps (depending on the insurance amount), a simple medical exam to confirm the applicant's health. (For convenience, as used herein, the term “applicant” means the proposed insured, although it should be appreciated that in some cases the applicant for insurance may be a person other than the proposed insured.)

When the applicant is older or perhaps has a history of medical conditions, the amount of medical information on the applicant and the underwriting process can be more complex. It often is conducted by a trained and experienced underwriter. The underwriter may use resources (books, databases, and the Internet) to access information concerning medical conditions, avocations, or other mortality influencing factors, to determine not only the insurability of the applicant, but the mortality risk (and thereby determine the amount of a premium needed to reasonably account for that risk).

Computers have been used to assist the underwriter. They can provide access to databases of medical information (either stored in the computer or available over networks, such as the Internet). In some cases, systems have been developed to assist the underwriter in identifying conditions (based on applicant information) and even provide a rating or weight to that condition. The rating assesses the mortality risk for the condition. For example, methodologies employed by many underwriters assign a rating (in one or more increments of 25 points) to each condition. A total rating of 100 over the standard rating indicates that the applicant has twice the mortality risk (over a given period of time) than a person with a standard rating. Ratings are based on empirical data on mortality risks and on medical literature collected by insurers and others over many years for each of many known conditions. When computers have been used, the underwriter is able to identify the condition and have a database provide a rating for that condition, rather than having to consult a manual or other printed documentation.

One of the issues facing underwriters that use computers is that underwriting is not an exact science, but rather requires judgment on the part of the underwriter as to whether a given condition should truly have the rating assigned to it in ratings manuals (as reflected in the computer's database). For example, if an applicant has a height and weight that suggests mild obesity, rating manuals will normally assign a rating (say, 25 points) to reflect a higher risk of mortality. However, if the underwriter notes from the applicant's background information that the applicant has a large build, low body fat, exercises regularly, and has elderly parents still alive, the height and weight data may be misleading (at least as to mortality risk). The applicant may be an athletic, well-muscled and active person with no mortality risk beyond normal.

Thus, there are many factors that an underwriter should reasonably take into consideration (that are not reflected in ratings manuals), and so it becomes difficult to automate the rating process using a system that merely assesses the applicant's condition and automatically provides a rating from previously collected empirical data.

### BRIEF SUMMARY OF THE INVENTION

There is provided, in accordance with the present invention, a system, graphical user interface and method for underwriting insurance.

In one embodiment, the system includes a processor, an input device, a display device, and a storage device. The processor is programmed to provide a graphical user interface on the display device for use by a user (underwriter), the graphical user interface including an underwriting super tab screen having one or more condition sub tab screens where ratings are displayed for conditions identified by the user, and a summary super tab screen for displaying a plurality of information categories (sub tabs or screens) concerning the applicant. The information categories including a condition summary which automatically captures and displays individual ratings for conditions selected by the underwriter and a total for all the individual ratings. The processor is further programmed for the underwriter to manually adjust both the individual ratings and the total of ratings displayed on the condition summary in order to reflect the judgment of the underwriter as to the appropriate total rating to be assigned to the applicant.

In another embodiment, a graphical user interface for use by an underwriter in underwriting insurance comprises a condition summary screen wherein a rating is displayed for a condition identified by the underwriter and wherein the rating may be manually adjusted by the underwriter, and a life expectancy screen that reflects the life expectancy of the applicant and that is displayed with the condition summary screen, the life expectancy based on both the age of the applicant and the rating displayed on the condition screen, so that as the rating on the condition summary screen is manually adjusted by the underwriter, any corresponding change in life expectancy is displayed on the life expectancy screen, thereby permitting the underwriter to determine, from the life expectancy screen, the impact of any rating adjustment on life expectancy of the applicant.

A more complete understanding of the present invention may be derived by referring to the detailed description of the invention and to the claims, when considered in connection with the Figures.

### BRIEF DESCRIPTION OF THE DRAWINGS

FIG. 1 is a general block diagram showing an underwriting system in accordance with the present invention.

FIG. 2 is a flow diagram illustrating the overall underwriting process using the system of the present invention.

FIG. 3 illustrates the various databases of the underwriting system and their relationship to the graphical user interface screens (super tabs and sub tabs) used by an underwriter.

FIG. 4 is a view the Summary Sheet (super tab) screen.

FIG. 5 is a view of the Proposed Insured screen (seen as a sub tab of the Summary Sheet screen of FIG. 4), illustrating various fields of data entered therein.

FIG. 6 is a view of the Exam screen (sub tab) of the Summary Sheet screen.

FIG. 7 is a flow diagram illustrating a rating process using the underwriting system of the present invention for selecting a medical condition, determining a rating therefor, and displaying such rating in the Condition Summary (sub tab) screen.

FIG. 8 is a view of the Condition Summary screen (sub tab) used in rating process illustrated in FIG. 6.

FIG. 9 is a view of the Find Condition screen displayed when the condition search button is selected in the rating process of FIG. 7.

FIG. 10 is a view of the Medical Condition screen (sub tab) used in the rating process of FIG. 7.

FIG. 11 is another view of the Medical Condition screen (sub tab) used in rating process of FIG. 7, illustrating rating information for a “malaria” condition.

FIG. 12 is another view of the Condition Summary screen (sub tab), similar to that of FIG. 8, but showing the addition of a rating for a “malaria” condition.

FIG. 13 is another view of the Summary Sheet screen (super tab), similar to that of FIG. 4, but showing the addition of a rating for a “malaria” condition.

FIG. 14 is a view the Medical Condition (sub tab) screen, where the “notes” sub-option has been selected.

FIGS. 15 through 18 illustrate the Non-Medical, Financial, International and Older Age screens (sub tabs) found under the Underwriting Super Tab.

FIG. 19 is a view the Resources (super tab) screen.

FIG. 20 is a view of the CAD profile screen.

FIG. 21 is a view of the diabetes profile screen.

### DETAILED DESCRIPTION OF THE INVENTION

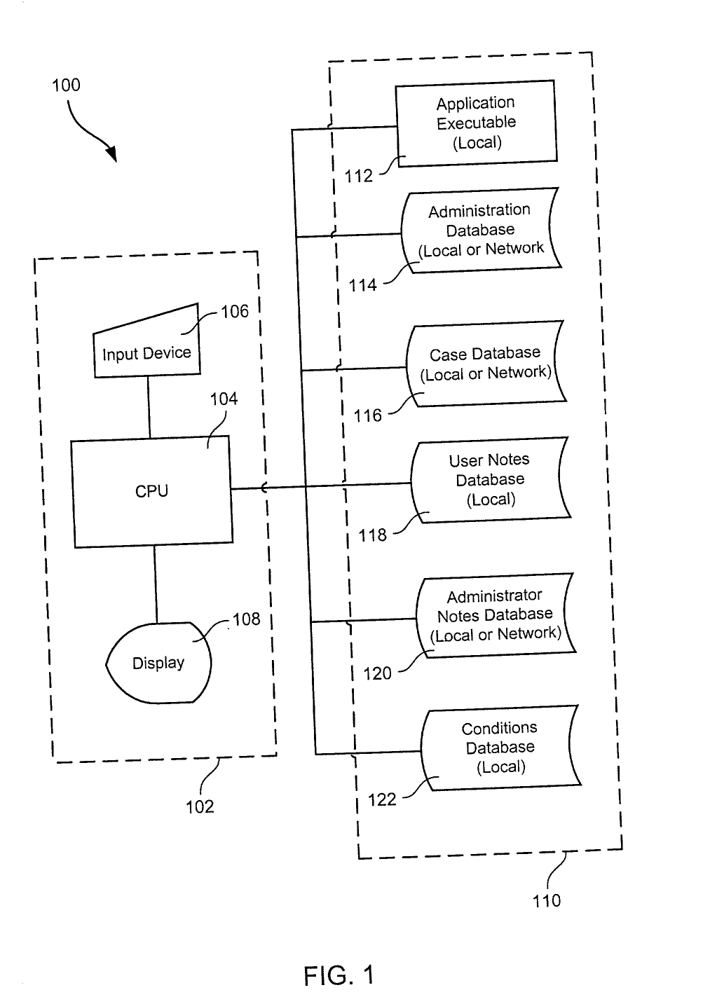

Referring now to FIG. 1, the hardware, software and database components of an underwriting system 100 in accordance with the present invention are illustrated. The illustrated system 100 is used by an underwriter for underwriting life insurance policies, and includes a workstation 102 having a central processing unit (CPU) 104, an input device 106 (e.g., keyboard, mouse, etc.), and a display 108 (CRT, LCD screen, etc.). The workstation uses a data storage device or system 110 that has application executable code 112, an administration database 114, a case database 116, a user notes database 11 8, an administrator notes database 120 and a conditions database 122.

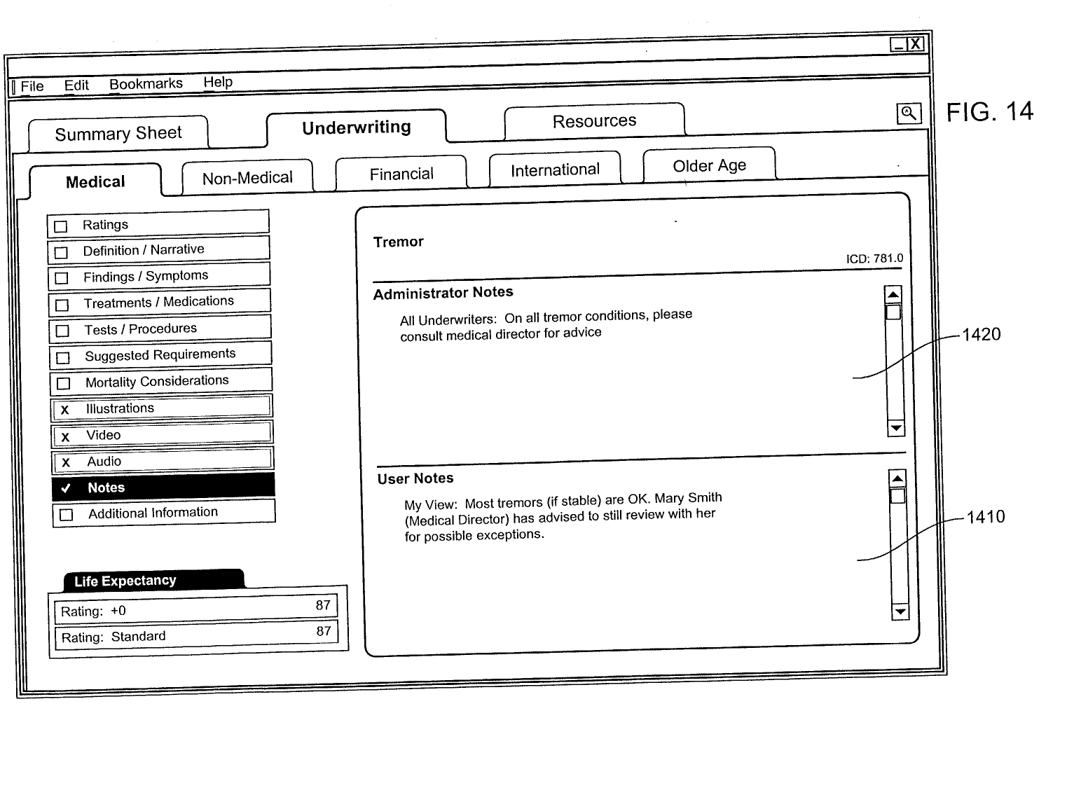

The application executable code 112 consists of the software code executed by the CPU 104 during the operation of the underwriting system, such operation implemented by various processes and graphical user interfaces (screens) to be described later. The administration database 114 contains user names and passwords for all users (underwriters) that are authorized to use the underwriting system 100 (when a user logs in, he or she enters his/her name and password at the input device 106 and they are checked against those stored in the administration database 114). The case database 116 stores data entered or collected (e.g., at the input device 106) on individual insurance applicants and that is used by the underwriter to determine the insurability, mortality and a rating for those applicants. The user notes database 118 and the administrator notes database 120 are used to store notes and other information collected over time, and that either a central administrator or an individual user may need access to, for purposes of evaluating medical and other conations (these notes will be illustrated later in conjunction with FIG. 14).

The conditions database 122 stores preloaded information about medical and other conditions, and ratings and other insurability/morality information pertaining to those conditions, that an underwriter will need to consider in evaluating any medical or other condition applicable to a life insurance applicant. Such information will likely be vast because of the thousands of potential conditions that might be applicable to life insurance applicants and would include, for example, information originating from underwriting manuals, medical books, and other public sources that is stored electronically in database 110 for easy access by the underwriter. The conditions database and various examples of information stored therein will be described in greater detail later.

The system 100 can be a stand-alone system (e.g., a single personal computer) or part of a network, depending on the needs and circumstances of the user. As illustrated in FIG. 1, and for reasons that will become apparent as this description progresses, in either case (stand-alone or network-based) the application executable code 112, user notes database 118 and conditions database 122 may be located in local memory (e.g., part of a personal computer memory system) and would be used only by the user at that workstation 102. The administration database 114 (containing user names and passwords), the case database 116, and the administrator notes data base 120 are located in either local memory (if a stand-alone system), or if the system 100 is part of a network, in a remote memory maintained by the network, and thus would be accessible to all users on the network.

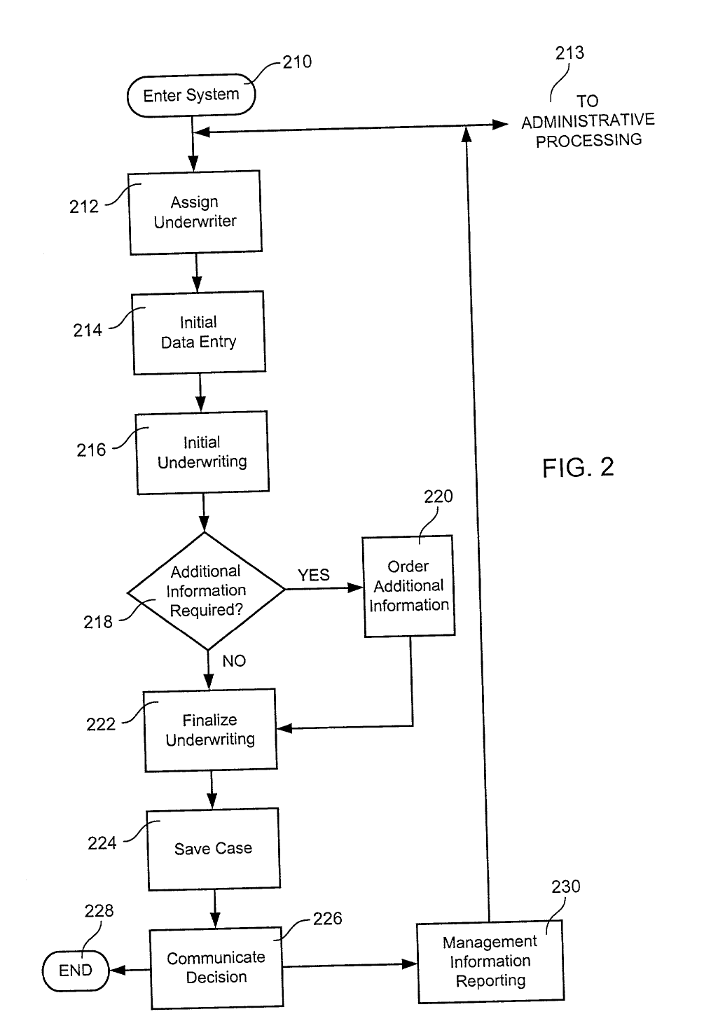

In FIG. 2 there is illustrated an overall underwriting process that can be implemented using the system 100 of FIG. 1. When the user (underwriter) enters the system (step 210), the user's name and password are checked at the administration database 114, and if the user is authorized, he or she may proceed with underwriting. Underwriting cases may either be new or already established, and if new, the underwriter may establish or assign himself as the responsible underwriter (step 212).

In some cases, as will be described below, various kinds of data may be imported from an administrative system 213 and need not be entered at the system 100. For example, if personal information on the insurance applicant (e.g., name, age, birth date, gender) has already been collected directly from the applicant at the centralized administrative system 213 (e.g., entered by a clerical employee from information received from the applicant over the telephone or from an insurance application), it can then imported into system 100 so that basic information will have been pre-loaded or stored relative to a case (i.e., a proposed insurance policy) before the case is accessed by an underwriter. As another example, the administrative system may assign underwriters to cases as they are received at the administrative system, so that when an underwriter enters the system 100, he will see both old cases already worked on as well as new cases that have been assigned to him/her. In the process illustrated, the underwriter would most likely have also received a physical file containing the insurance application, medical information (such as medical exam report, attending physician statement, etc.) and can begin using the system by first entering data (e.g., applicant information if not preloaded by the administrative system) and other pertinent information on the applicant (e.g., medical exam or lab results) at step 214.

At the next step 216, the underwriter begins the actual underwriting process by determining if any disclosed condition (medical or other conditions) requires a “rating”, i.e., a debit or credit of points reflecting the insurability/mortality of the applicant. This process will be described later in connection with the graphical user interfaces provided to the underwriter by the system 100, but it is a process well understood by underwriters and in the past has been largely done manually (e.g., search for an identified conditions in medical books or other resources and then looking up the corresponding rating for that condition in the underwriting resources). In the system 100, such ratings are stored in the conditions database 122 and, as will be described later, once a condition is identified and the corresponding rating determined and displayed at the display 108, it may be selected by the underwriter and automatically transferred into the applicant's case (as maintained in the case database 116).

As part of the initial underwriting, the underwriter may need additional information, step 218. For example, if a past disease has been identified, the underwriter may want assurances that it has been completely resolved and is no longer a factor in the applicant's mortality. The underwriter may want a statement from the applicant's physician to that effect. As another example, the applicant's weight and build may indicate that the applicant is possibly overweight, but all other indications are that he is in good health. Perhaps the underwriter may want further information from the applicant, such as exercise habits, family history (the current age or age of death of parents), etc. Such additional information is ordered by the underwriter (step 220), and after it is received the underwriter may then finalize the underwriting (by determining a final rating for the applicant) at step 222, and saving all the information collected for the case (including ratings, underwriter notes and personal information collected) at step 224.

The underwriter's decision (accept, decline, accept with additional premiums because of ratings above standard, postpone because of unresolved conditions etc.) is then communicated (step 226). The communication is normally made to a management reporting system (step 230), which can generate, for example, letters to the applicant or to the applicant's agent. At the same time, a report can be made back to the administrative system 213, which may be used to maintain information on applicants, as well as issue and maintain insurance policies (e.g., send out premium notices). Once the underwriter has completed underwriting, and communicated the decision, the process ends at step 228.

The remainder of this description will largely focus on the implementation of steps 216 and 222 in the flow diagram of FIG. 2., i.e., the actual underwriting process and the graphical user interfaces provided by the system 100 in order to enable the underwriter to perform that underwriting process.

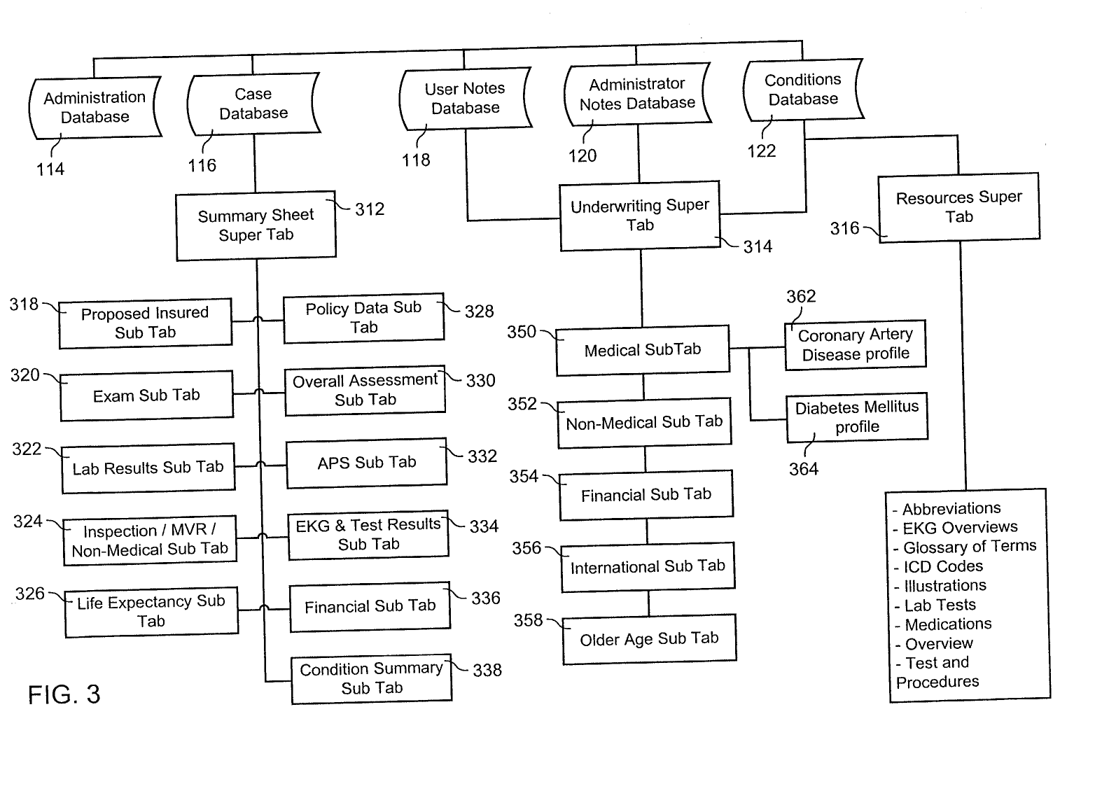

In FIG. 3, there are shown the various databases 114 through 122 (previously described in connection with FIG. 1) and their relationship to various tabs and screens that appear in the graphical user interfaces (GUIs) provided by the system 100. In particular, there are three major tabs (“Super Tabs”) displayed to the underwriter, and identified in FIG. 3 as the Summary Sheet Super Tab 312, the Underwriting Super Tab 314 and the Resources Super Tab 316. By way of explanation, it should be understood that the term “tab” refers to a heading for a screen or window displayed on the GUI. A “super tab” is a major tab or heading (of which there are three—the Summary Sheet Super Tab 312, the Underwriting Super Tab 314 and the Resources Super Tab 316) and through which the underwriter can access a plurality of “sub tabs” (and their associated screens) associated with each super tab. The sub tabs can be used to either view or enter data associated with the subject matter of that sub tab.

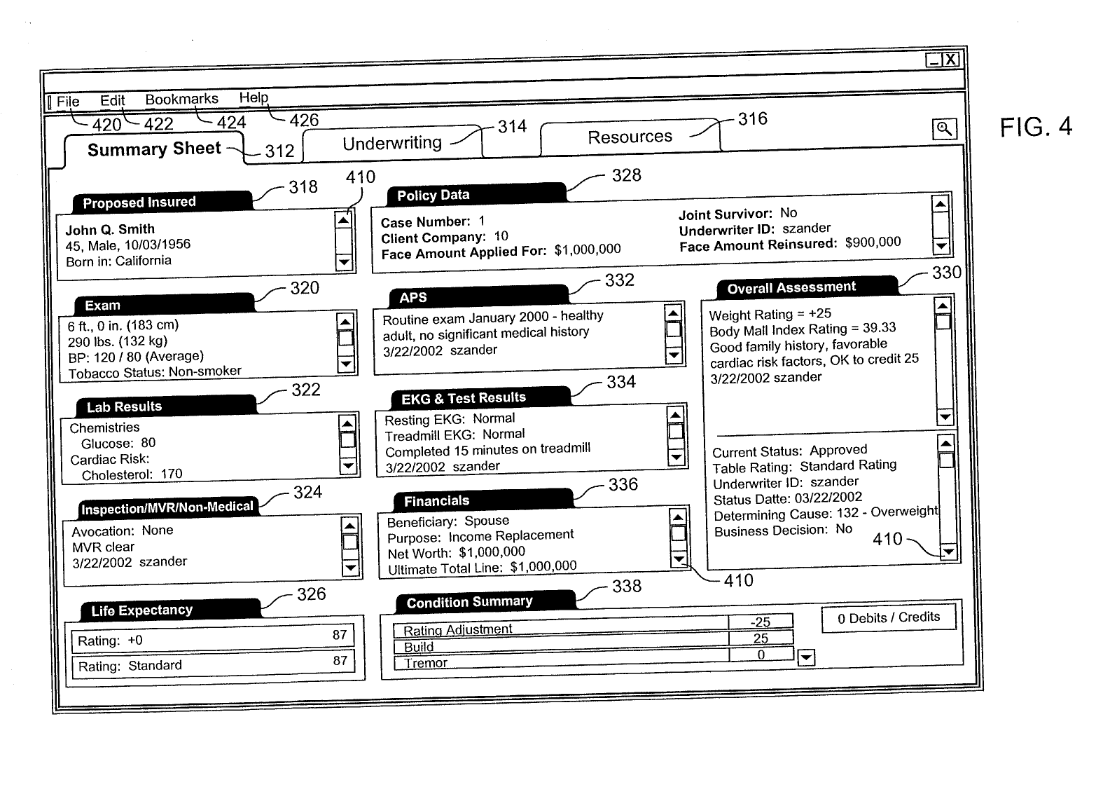

As an example of this, and referring to FIG. 4 in conjunction with FIG. 3, there is shown the graphical user interface or screen that displays the three super tabs 312, 314 and 316, and by virtue of having selected the Summary Sheet Super Tab 312, there is shown each of the sub tabs or windows that can viewed under the Summary Sheet. The sub tabs or screens under the Summary Sheet Super Tab 312 (as illustrated in FIG. 3 and as seen in the GUI of FIG. 4), include a Proposed Insured Sub Tab 318, an Exam Sub Tab 320, a Lab Results Sub Tab 322, an Inspection/MVR/Non-Medical Sub Tab 324, a Life Expectancy Sub Tab 326, a Policy Data Sub Tab 328, an Overall Assessment Sub Tab 330, an APS (attending physician statement) Sub Tab 332, an EKG & Test Results Sub Tab 334, a Financial Sub Tab 336 and a Condition Summary Sub Tab 338. The specific content displayed (or entered) at the screens represented by these sub tabs 318-338 will be described later.

Returning to FIG. 3, it can be seen that the Summary Sheet Super Tab 312 organizes and displays data from the case database 116. As indicated earlier, the case database stores information collected on each insurance applicant. Thus, the system 100 retrieves (or stores) data from that database for display under the Summary Screen and each of the sub tabs or screens associated with it. As also seen in FIG. 3, the Underwriting Super Tab 314 organizes and displays data from the User Notes Database 118, Administrator Notes Database 120 and the Conditions database 122. Thus the system 100 retrieves (or stores) data from those databases for display under the Underwriting Super Tab 314 and each of the sub tabs associated with it. Those sub tabs under the Underwriting Super Tab 314 are shown in FIG. 3 as the Medical Sub Tab 350 (having associated profile screens 362 and 364), Non-Medical Sub Tab 352, Financial Sub Tab 354, International Sub Tab 356 and Older Age Sub Tab 358 (the content of each will be described later).

Finally in FIG. 3, there is shown the Resources Super Tab 316, which displays resource data from the Conditions Database 122. The appearance of the Resource Super Tab and associated screens will be described in greater detail later. Briefly, and as illustrated in FIG. 3, the Resources Super Tab 316 provides the underwriter with access to background and related information on various medical conditions, and includes medical abbreviations, EKG overview information (background and explanations), glossary of medical terms, ICD (International Class of Diseases) codes, graphical illustrations (still pictures and videos of, for example, anatomy and the effect of medical conditions on the anatomy), explanations of lab tests (and their relevance in understanding and diagnosing medical conditions), an overview of each identified medical condition in the Conditions database 122, and finally the known tests and procedures that can be used in the diagnosis and treatment of various medical diseases and conditions. These resources stored in the database are accessed by the underwriter electronically through the system 100 for informational purposes, when encountering, e.g., medical conditions (including terminology, diagnoses, and associated medical procedures) that the underwriter may not be familiar with, and in lieu of manually locating medical dictionaries, treatises and other traditional and non-electronic resources.

It should be understood that while the information illustrated as accessible under the Resources Super Tab 316 are directed to medical conditions (because of their often complex nature), non-medical information could also be accessed if desired (and stored).

Referring now to FIG. 4, the Summary Sheet Super Tab 312 and the sub tabs and screens associated therewith will be described. Except as noted otherwise, the various tabs are used to collect, organize and display the typical data used by underwriters in evaluating a life insurance applicant. The following Table I provides, for each of the displayed sub tabs in FIG. 4, examples of data collected therein. It should be appreciated that the examples are only for illustration, and data other than that described or shown can be collected, organized and displayed, depending on the needs of individual underwriters and insurance carriers.

TABLE I

| Sub Tab | Data Examples |
|---|---|
| Proposed Insured Sub Tab 318 | First Name |
| | Middle Initial |
| | Last Name |
| | Age |
| | Date of Birth |
| | Sex |
| | Birth State |
| | State of Residency |
| Exam Sub Tab 320 | Height |
| | Weight |
| | Blood Pressure |
| | Tobacco Status (Non-Smoker, |
| | Smoker) |
| Lab Results Sub Tab 322 | Chemistries (Cellulose, Fruc- |
| | tosamine, Bun, etc.) |
| | Cholesterol |
| Inspection/MVR/Non-Medical | Avocation |
| Sub Tab 324 | Motor Vehicle Report |
| Life Expectancy Sub Tab 326 | Life Expectancy (with assigned rating |
| | points) |
| | Life Expectancy (standard rating) |
| Policy Data Sub Tab 328 | Underwriting Case Number |
| | Client Company (insurance carrier) |
| | Face Amount Applied For |
| | Joint Survivor (yes/no) |
| | Face Amount Reinsured (if |
| | reinsurance carrier) |
| | Underwriter I.D. |
| | Issuing Policy Number |
| Overall Assessment Sub Tab 330 | Current Status (approved, decline, |
| | postpone, etc.) |
| | Rating |
| | Underwriter I.D. |
| | Status Date |
| | Determining Cause (for each rating) |
| | Business Decision (yes/no) |
| | Overall Assessment Notes |
| APS (Attending Physician | Notes From APS |
| Statement) Sub Tab 332 | |
| EKG & Test Results Sub Tab 334 | EKG Results (normal, abnormal) |
| | Notes From EKG Test |
| Financials Sub Tab 336 | Occupation |
| | Beneficiary |
| | Purpose of Insurance |
| | Income of Applicant |
| | Net Worth of Applicant |
| | Insurance In Force |
| | Amount Applied For |
| | Amount Being Replaced |
| | Ultimate Total Line (In Force & |
| | Applied For) |
| | Financial Verification (yes/no) |
| | Financial Notes |
| Condition Summary Sub Tab 338 | Condition Name |
| | Condition Rating |
| | Notes (from underwriter) |

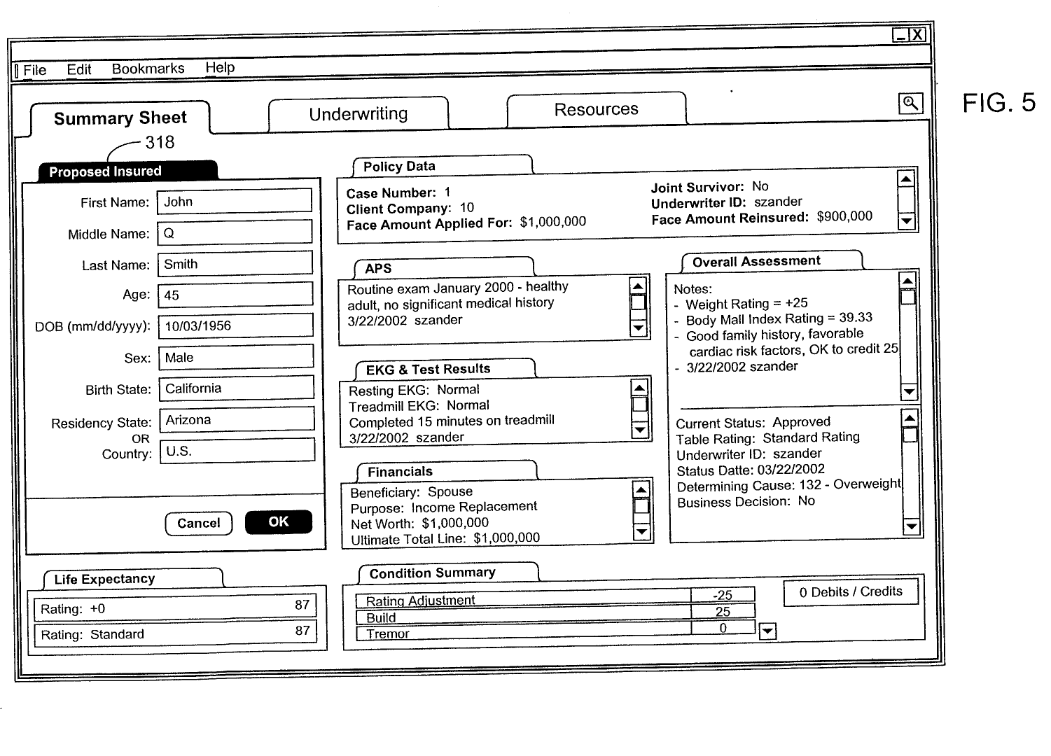

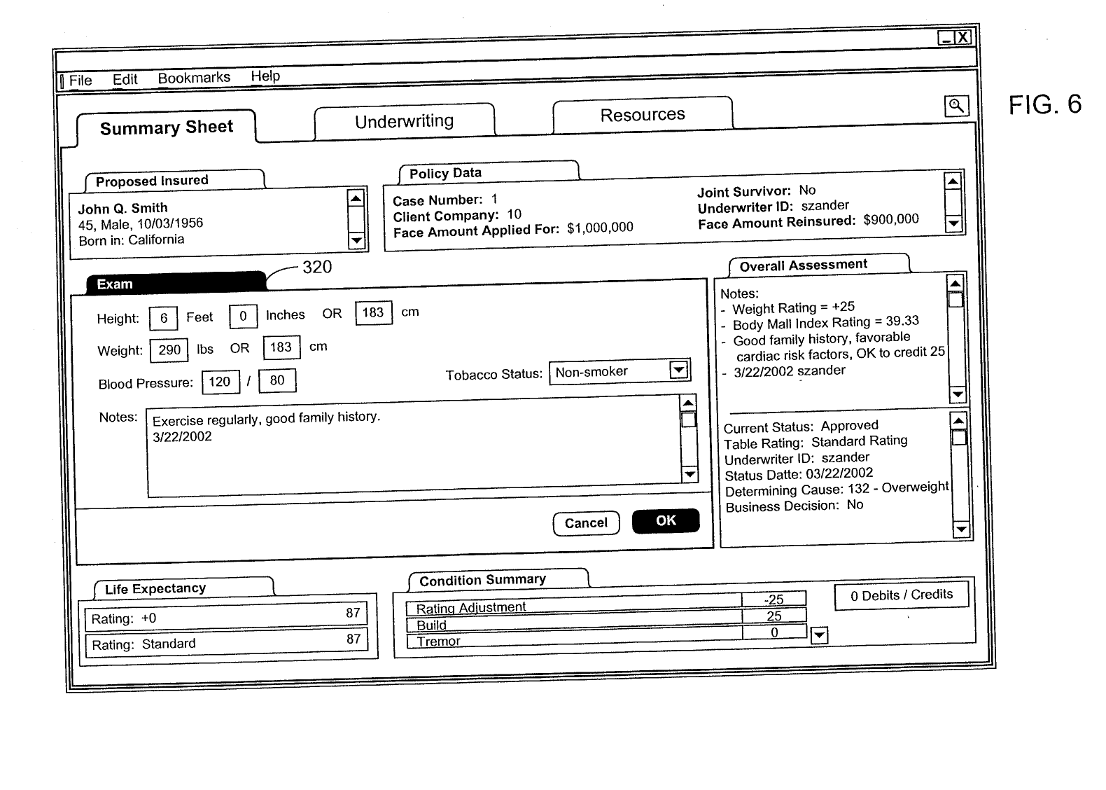

As Examples, FIGS. 5 and 6 illustrate two windows or screens accessed from (opened or expanded, to thereby overlay) the Summary Sheet 312, namely the Proposed Insured Sub Tab screen 318 and the Exam Sub Tab Screen 320, for purposes of entering data therein (or displaying all data previously entered). Each of these screens has been opened by selecting (“clicking”) the corresponding sub tab on the Summary Sheet 312 in FIG. 4. As can be seen, the data displayed at these screens 318 and 320 in FIGS. 5 and 6 may be entered as part of a required or defined field (see, e.g., each of the Name, Age, DOB, Sex, Birth, State, Residency State and Country fields in the Proposed Insured screen 318, and the Height, Weight and Blood Pressure and Tobacco Status fields in the Exam screen 320). Other data may be simply entered as free form data or notes (see the “Notes” field of the Exam screen 320). Obviously, all data entered (whether as part of a defined field or as free form notes) can be useful to the underwriting process. However, certain defined fields are useful for carrying out some aspects of the present invention, such as the Age field in the Proposed Insured screen of FIG. 5, the significance of which will be described later.

Still referring to FIG. 4, it can be seen that, since there is limited space for displaying the data entered in the sub tabs in the Summary Sheet screen, scroll bars 410 are provided at most of the sub tabs 318-338 (where needed) to enable the underwriter to scroll up or down to display the data associated with the sub tabs. As should be apparent, in lieu of scrolling, each of the sub tabs can be selected (such as illustrated in FIGS. 5 and 6) to also expand the sub tabs from their abbreviated or condensed form seen in FIG. 4, in order to fully display data.

As also seen in FIG. 4, headings for conventional “windows-type” drop down menus are provided, such as “File” 420 (to create a new file, open an existing file, save a file, print a file, etc.), “Edit” 422 (to cut, copy, paste), “Bookmarks” 424 (to add, delete and display bookmarks—hypertext links—to websites) and “Help” 426 (to access help topics on use of the system).

The Life Expectancy Sub Tab 326 and Condition Summary Sub Tab 338 are particularly noteworthy, and their use in the underwriting process will now be described in conjunction with FIGS. 4, 7, 8 and 10. Before proceeding with that description, however, it should be noted that in an embodiment of the invention, the Life Expectancy Sub Tab 326 will be present and displayed across a number of screens seen by the underwriter so that, as the underwriter establishes (and changes) ratings on an applicant (proposed insured), any affect of the rating (or change of a rating) on the life expectancy of the applicant will be displayed and be readily available to the underwriter, as will be described shortly.

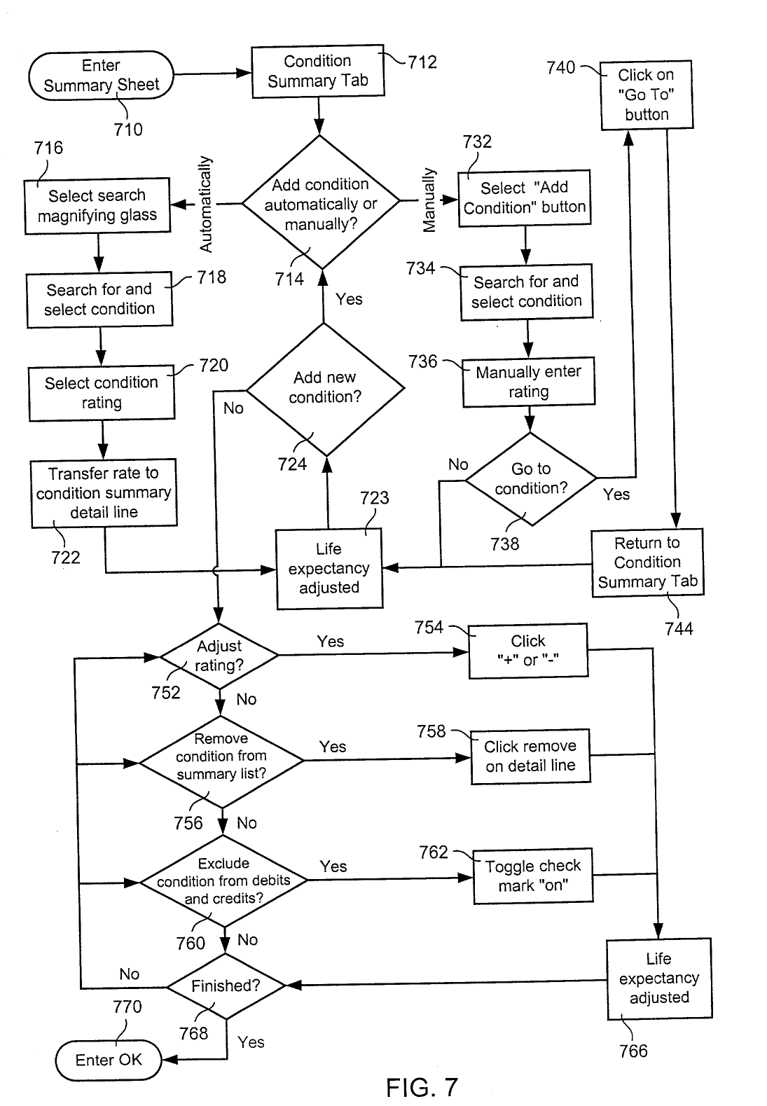

FIG. 7 is a flow diagram illustrating the process by which an underwriter selects a condition (e.g., under the Underwriting Super Tab 314), determines a rating, transfers that rating to the Condition Summary Sub Tab 338, adjusts or otherwise modifies the rating (either individually or collectively) to arrive at a total rating (debits/credits), and at the same time sees the affect of the rating on the projected life expectancy of the applicant (displayed at the Life Expectancy Sub Tab 326).

Before proceeding with the description of FIG. 7 (and associated Figures), it should be noted that the process of FIG. 7 has three major sub-processes in order to provide flexibility to the underwriter in establishing a rating for the applicant:

(1) an automatic selection of a rating using ratings provided in the Conditions Database 122, with such sub-process generally represented by steps 716 through 722;

(2) a manual selection and entry of a rating based on the underwriter's own assessment of the needed rating for any identified condition, with such sub-process generally represented by steps 732 through 744; and

(3) modification or adjustment of the rating, based on the underwriter's subjective judgment as to how high (number of credits/debits) a rating should be for any individual condition or all identified conditions taken together, with such sub-process generally represented by steps 752 through 768.

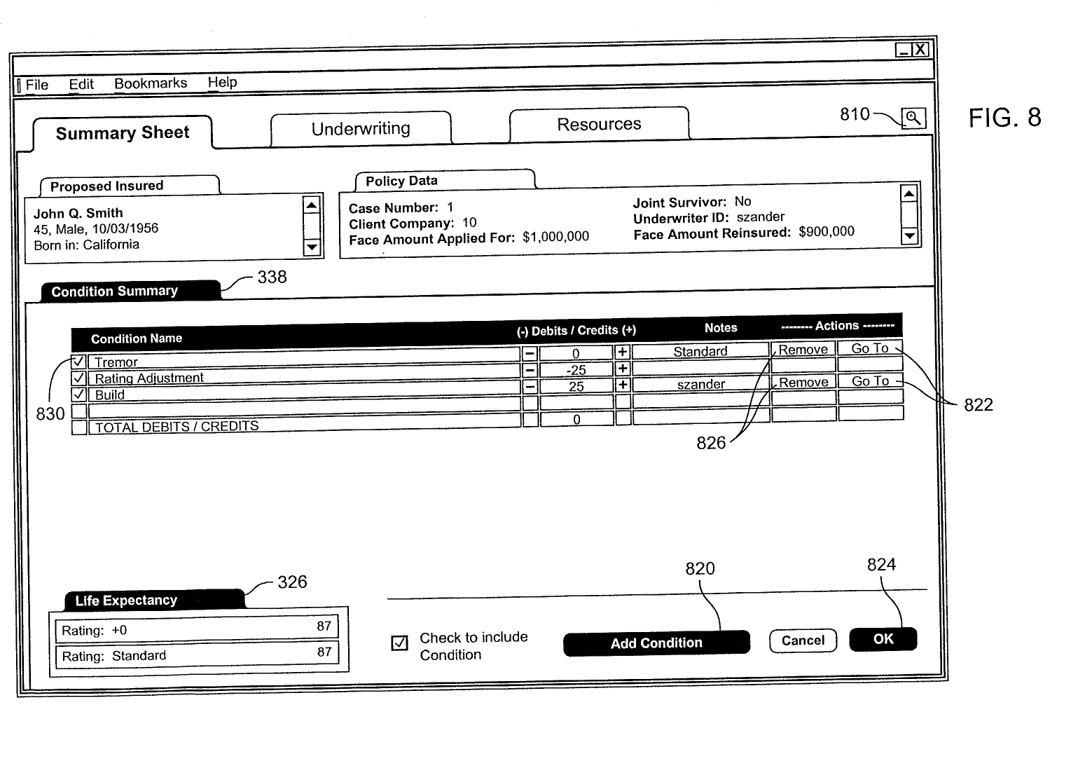

In FIG. 7, it is assumed that the underwriter has already collected (or the system has imported) information on the applicant (e.g., from a medical questionnaire, medical exam, attending physician statement, etc.) and has determined that there are medical or other conditions for the applicant that may affect the ratings (debit/credit points) to be assigned to the case. The rating process is begun by the underwriter by entering the Summary Sheet (see screen in FIG. 4) at step 710, and opening the Condition Summary Sub Tab 338, step 712. The Condition Summary Sub Tab 338, after having been selected (with some conditions and ratings already established) is illustrated in FIG. 8. The underwriter then decides whether to add a condition (and an associated rating ) automatically or manually at step 714. The decision will be made by the underwriter based on his or her comfort with the condition and his/her knowledge as to its impact on mortality.

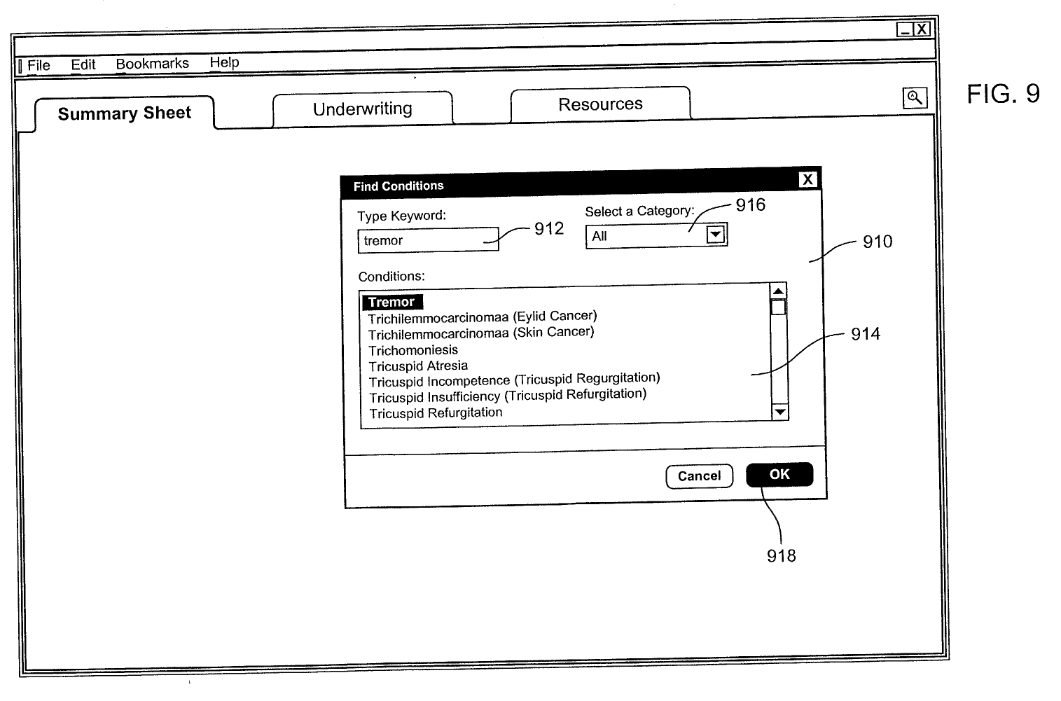

If the underwriter chooses to add a condition automatically, a search for the condition is made at step 716 by selecting the magnifying glass icon 810 seen in FIG. 8 (and other Figures), causing the Find Conditions screen 910 to appear (see FIG. 9). At the screen 910 the underwriter searches for the condition (step 718) by either entering a keyword (box 912) or scrolling through the alphabetical list of conditions (box 914) until the desired condition appears. Note also that a category box 916 may be used to select “all” categories of conditions (as illustrated in FIG. 9) or may be used to select individual categories of conditions (not seen in FIG. 9), such as medical, non-medical, financial, international, older age, etc.

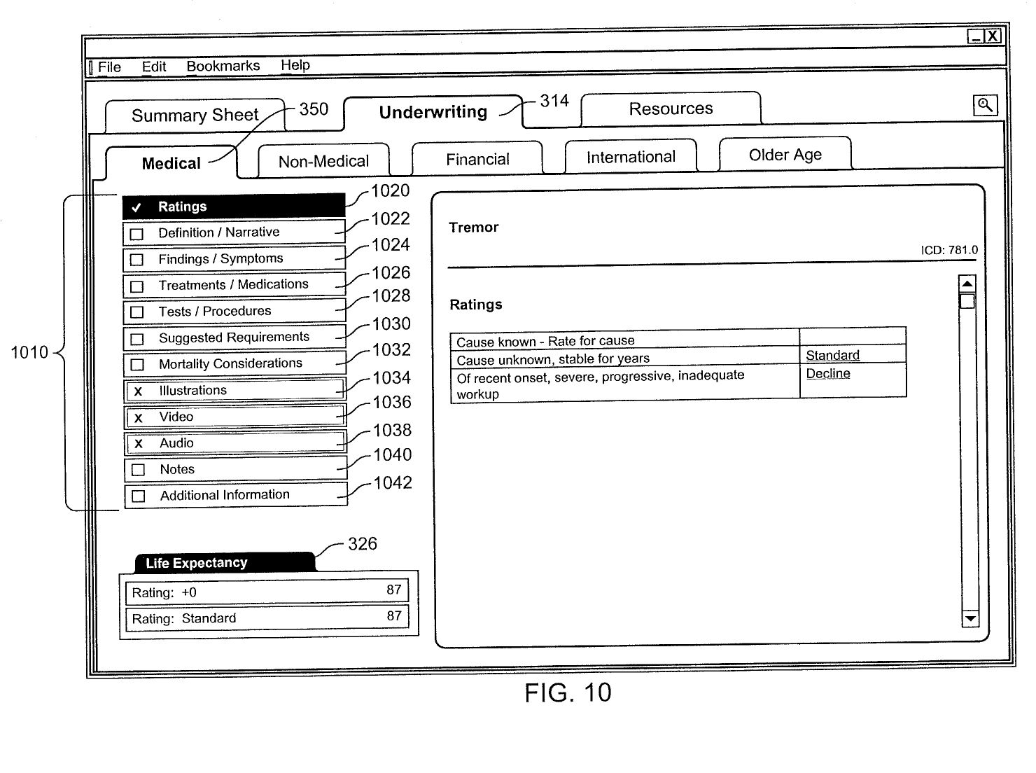

The condition is selected (“OK” button 918) and rating information stored in the conditions database appears (see FIG. 10) under the Medical Sub Tab 350 of the Underwriting Super Tab 314. In FIG. 10, the condition selected (as an example) and the rating information presented are for a “tremor” condition. The rating information on that screen presents several different forms or characteristics of the condition such as “Cause known-Rate for cause” (indicating that the tremor has an identified cause and the underwriter should search for the condition reflecting that cause in order to determine a rating), “Cause unknown, stable for years” (indicating that for many years the tremor has not become progressively worse), to which is assigned a “standard” rating (i.e., 0 points or credits), or “Of recent onset . . . ”, in which case the underwriter is advised to decline coverage (for obvious reasons). In FIG. 10, it is assumed that the underwriter has information that the tremor is longstanding and stable, and the standard rating is selected (clicked) at step 720 (FIG. 7), causing the rating to be automatically transferred (step 722) so as to appear in the Condition Summary Sub Tab in FIG. 8 (seen as a “tremor” condition with “0” points as a rating (debit/credit)). When a rating is transferred to the Condition Summary screen, the life expectancy of the applicant is automatically adjusted or calculated (step 723) and the underwriter decides whether to add a new condition (step 724). If a new condition is to be added, the process returns to step 714.

If the underwriter decides at step 714 to add a condition manually, the “Add Condition” button 820 (seen near the bottom of the Condition Summary screen in FIG. 8) is selected at step 732, and the Find Condition screen 910 (FIG. 9) appears, enabling the underwriter to locate and select a condition (step 734). However, at step 734, rather than presenting a condition screen and ratings (as was earlier described in connection with the automatic rating sub-process steps 716-722 and the screen in FIG. 10), the system at step 734 merely adds the selected condition to the Condition Summary screen (FIG. 8) without a rating (i.e., assigns a “0” under “debit/credit” for that condition, so that the underwriter may manually enter the rating, step 736). Manual entry of the rating is accomplished by using (clicking) the “−” and “+” buttons adjacent the “debits/credits” column (FIG. 8) to increment the rating up or down until arriving at a rating that the underwriter is comfortable with. In the embodiment shown, ratings may be credited (or debited) in increments of 25 points.

It should be apparent from the forgoing description that, if the underwriter had selected “tremor” at step 734, the display would be as illustrated in FIG. 8, with the “Condition Name” showing “tremor” and the “debits/credits” column showing “0” points (until adjusted by the underwriter). However, even if the rating has been entered manually, the underwriter may, at step 738, chose to go to the appropriate condition screen (such as the screen for “Tremor” seen in FIG. 10). As will be described later, the underwriting screens permit the underwriter to further research the condition (for information) if helpful in arriving at a manually entered (or adjusted) rating for the identified condition. The underwriter can go to the conditions screen by selecting (step 740) the “Go To” button 822 seen to the right of the condition at the Condition Summary screen (FIG. 8). After viewing the condition, the underwriter returns to the Condition Summary screen (step 744). The life expectancy of the applicant is automatically adjusted to reflect the manually entered rating (step 723), and the underwriter then decides whether to add a new condition, step 724.

After the underwriter has transferred all ratings automatically or entered all ratings manually (as well as at any other time during the underwriting process), the underwriter may still adjust ratings (individual or total) in order to account for the underwriter's subjective view of the mortality of the applicant. This is illustrated at steps 752 through 768 in FIG. 7. In particular, the underwriter decides whether to adjust any individual rating by using the “+” and “−” buttons (see FIG. 8) next to that rating (steps 752 and 754). The underwriter may also chose to remove any condition (and its rating) from the Condition Summary by selecting the “Remove” button 826 seen in FIG. 8 (steps 756 and 758). The underwriter may also chose to exclude any condition from the calculation of the rating (total debits/credits), by removing the checkmark next to that condition in the appropriate check box 830 in FIG. 8 (steps 760 and 762). In this adjustment, the condition and rating remain displayed (but are not included in the “Total Debits/Credits”). After any one of the foregoing adjustments, the life expectancy of the applicant is again automatically calculated or adjusted (step 766). The rating process then ends at steps 768 and 770, by selecting the “OK” button 824 on the Condition Summary screen (FIG. 8).

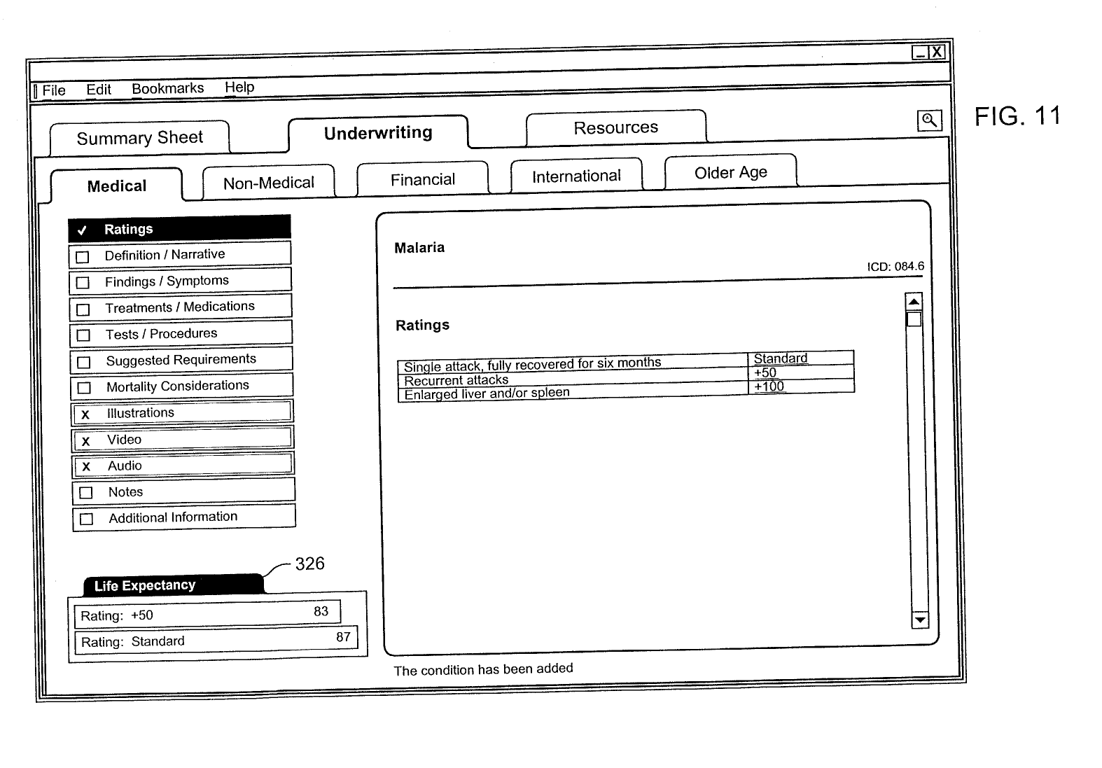

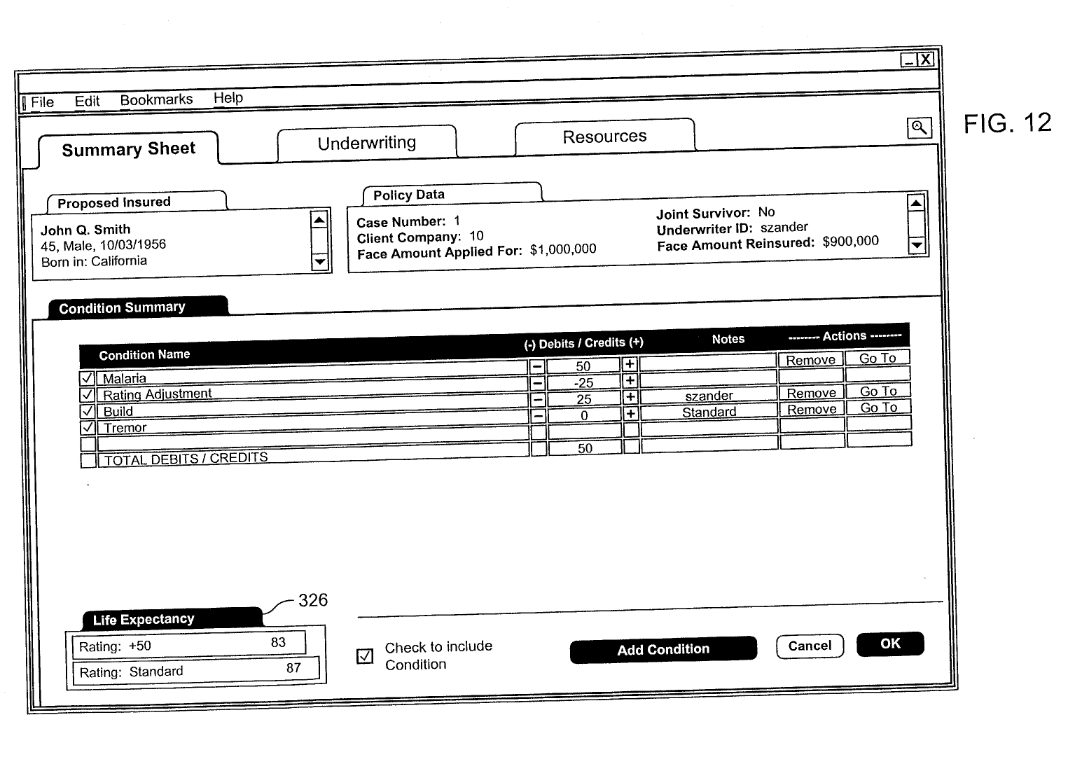

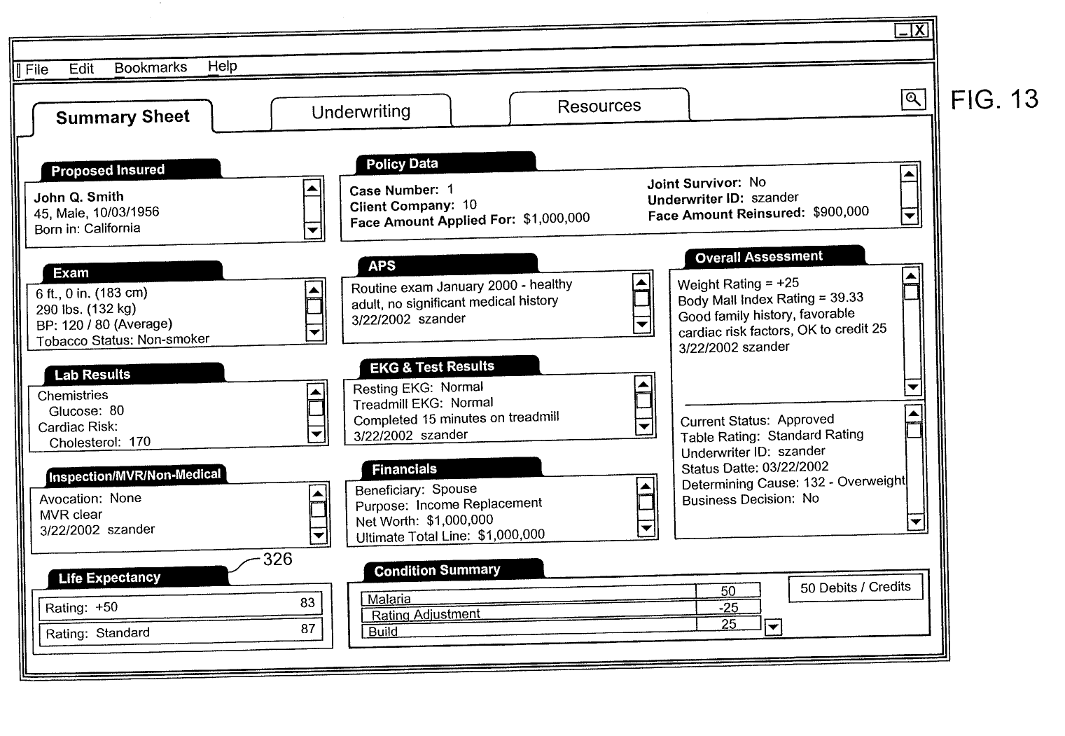

As a further example of the underwriting process using the system 100, FIG. 11 shows a medical condition screen that has been selected (e.g., at step 718 in FIG. 7) for “malaria”. As can be seen, a rating of “50” points is provided for “recurrent attacks” in the ratings information, and if that rating is selected or clicked (and if the automatic rating process steps 716 through 722 in FIG. 7 are used) that rating is automatically transferred to the Condition Summary screen for the applicant (see FIG. 12) and to the Summary Sheet Super Tab screen (see FIG. 13). Note in FIGS. 11, 12 and 13 that the addition of the condition and rating for malaria changes the total rating for the same applicant in comparison to earlier Figures, FIGS. 4, 5, 6, 8 and 10 and further note that the life expectancy for that applicant has now changed from 87 years to 83 years (as seen in FIGS. 11, 12 and 13).

The display of the life expectancy of the applicant under the Life Expectancy Sub Tab 326 (which appears on many of the screens, but particularly the Condition Summary screen), is especially useful to the underwriter when attempting to analyze and evaluate the mortality of the applicant. Underwriters are trained and familiar with process of assigning ratings to individual conditions, but many times it is difficult for the underwriter to actually assess how an individual rating will ultimately affect the projected mortality of the applicant. As an example, referring back to the screens of FIGS. 4 and 8, and as described earlier, the applicant reflected in the screens was manually assigned a rating (25 points) because of the applicant's condition “Build” (i.e., his weight in conjunction with his height are seen as making him moderately overweight.) The underwriter can see the actual mortality impact of that rating by viewing the Life Expectancy tab. It may be easier for an underwriter to confirm or ignore a condition for purposes of ratings when that mortality impact (i.e., life expectancy) is displayed. In the instant example, after seeing the effect of the build rating on the life expectancy, the underwriter decided to adjust the total rating by including an offsetting rating adjustment of 25 points, since it could be inferred from the other data on the applicant that he is athletic, exercises regularly, and has a good family history. The underwriter in this example subjectively determined that the life expectancy of this applicant should be no different than a similar applicant without the heavier weight (build) rating.

As illustrated in FIG. 8, the total rating is adjusted by incrementing or decrementing the “Rating Adjustment” shown as a condition name. This Rating Adjustment, in the illustrated embodiment, always appears on the Condition Summary screen (FIG. 8) to always give the underwriter the option of adjusting the total rating (steps 752, 754 in FIG. 7).

It should be noted that in each instance the Life Expectancy Sub Tab 326 shows the calculated life expectancy of the applicant (based on the total rating) as well as the life expectancy for a person of the same age without any rating points (i.e., a standard rating).

The life expectancy of the applicant can be readily computed (and then displayed at Life Expectancy Sub Tab 326) using any industry standard mortality table, such as the one seen in Appendix A. The table in Appendix A is simplified for purposes of illustration, showing only ages 0-50, and remaining years of life expectancy for Table Standard (i.e., standard rating), Table 1 (25 rating points) and Table 2 (50 rating points). Thus, for example, looking at the applicant whose personal information is displayed in the Summary Sheet of FIG. 12, the life expectancy (as displayed at the Life Expectancy Sub Tab 326) is computed by taking the current age (45 years old, retrieved from the defined age field in the Proposed Insured Sub Tab 318) and adding the remaining years of life expectancy shown in Appendix A:

| Rating | Life Expectancy |
|---|---|
| +50 | 83 (current age plus 37.72) |
| Standard | 87 (current age plus 41.77) |

(the computed life expectancy is rounded to the nearest whole integer year).

Further description of the Underwriting Super Tab 314 (Medical Sub Tab 350, Non-Medical Sub Tab 352, Financial Sub Tab 354, International Sub Tab 356, and Older Age Sub Tab 358) and Resources Super Tab 316 will now be provided.

Referring back to FIG. 10, the Medical Sub Tab 350 is seen as having a sub option menu 1010 for each condition. The menu 1010 includes a “Ratings” option 1020, a “Definition/Narrative” option 1022, a “Findings/Symptoms” option 1024, a “Treatments/Medications” option 1026, a “Test/Procedures” option 1028, a “Suggested Requirements” option 1030, a “Mortality Considerations” option 1032, an “Illustration” option 1034, a “Video” option 1036, an “Audio” option 1038, a “Notes” option 1040, and an “Additional Information” option 1042.

The Ratings option 1020 is perhaps the most frequently needed option, and is one that is illustrated as selected and displayed in FIG. 10. This option displays rating information and it is automatically displayed when the underwriter (in the process seen in FIG. 7) selects a condition and rating at steps 718 and 720, or goes to a condition at steps 738 and 740.

The other options (1022 through 1042) provide different categories of information to the underwriter about each condition, as set forth in the following Table II:

TABLE II

| Sub Option | Description of Display |
|---|---|
| Definition/Narrative Option 1022 | Definition (description) of the |
| | condition |
| Findings/Symptoms Option 1024 | Description of findings or |
| | symptoms likely observed when |
| | condition is present |
| Treatments/Medications Option 1026 | Description of treatments and |
| | medications typically prescribed |
| | for treating condition |
| Tests/Procedures Option 1028 | Description of tests and |
| | procedures typically used for |
| | diagnosing condition |
| Suggested Requirements Option 1030 | Description of items that are |
| | suggested for underwriter to |
| | evaluate condition |
| Mortality Considerations Option 1032 | Description of the possible affect |
| | of condition on mortality (life |
| | expectancy) of person having |
| | condition |
| Illustration Option 1034 | A graphical illustration (if |
| | available) showing condition (e.g., |
| | human anatomy with condition) |
| Video Option 1036 | A video clip (if available) showing |
| | condition |
| Audio Option 1038 | An audio clip (if available) |
| | explaining condition |
| Notes Option 1040 | Notes previously made by an |
| | administrator or by the underwriter |
| | concerning the condition |
| Additional Information Option 1042 | Additional information (if |
| | available) concerning the |
| | condition that is not found in other |
| | option displays |

While the details of each of the foregoing options under the sub option menu 1010 seen in FIG. 10 are apparent from the forgoing Table II, the notes option 1040 will be briefly described further (in conjunction with FIG. 14) because of its prior mention in connection with the user notes database 118 and administrator notes database 120 (FIGS. 1 and 3).

An example of the notes option 1040 and of the display associated with its selection is illustrated in FIG. 14. The notes option 1040 is displayed as two windows or sub screens, a user notes window 1410 and an administrator notes window 1420. As an example, the content of these windows in FIG. 14 relates to a “tremor” condition, with the user notes window 1410 displaying personal notes or comments of the underwriter made previously for that condition, and the administrator notes window 1420 displaying previously made notes or comments from the system administrator that are to be seen by all underwriters when viewing the condition. As mentioned earlier in conjunction with FIGS. 1 and 3, the user notes are stored in the user notes database 118 and the administrator notes are stored in the administrator database 120.

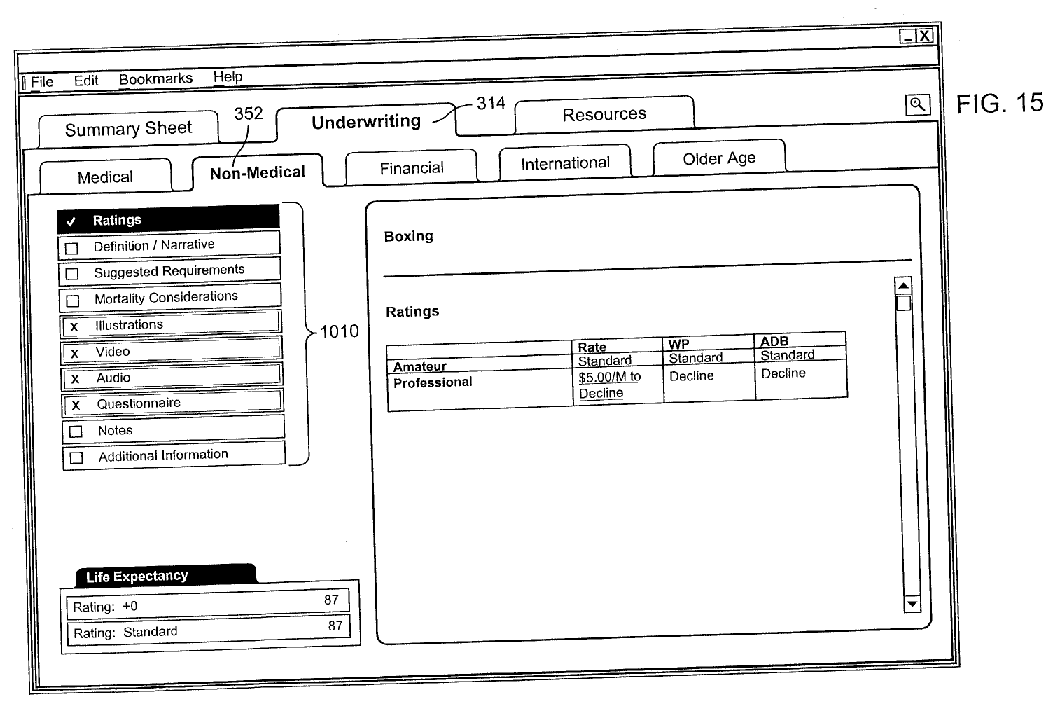

The remaining sub tabs under the Underwriting Super Tab 314 are illustrated in FIGS. 15 through 19. Briefly, the Non-Medical Sub Tab 352 contains underwriting information on various non-medical conditions or activities (occupations, avocations, etc.) for which ratings or other underwriting information may be given (e.g., because of mortality risk associated with those activities). The underwriter selects the activity (using a Find Condition screen such as that seen in FIG. 9) and can obtain information on that activity using, for example, the sub options menu 1010 described earlier in conjunction with FIG. 10. In FIG. 15, there is illustrated an example, namely rating information displayed for “boxing”.

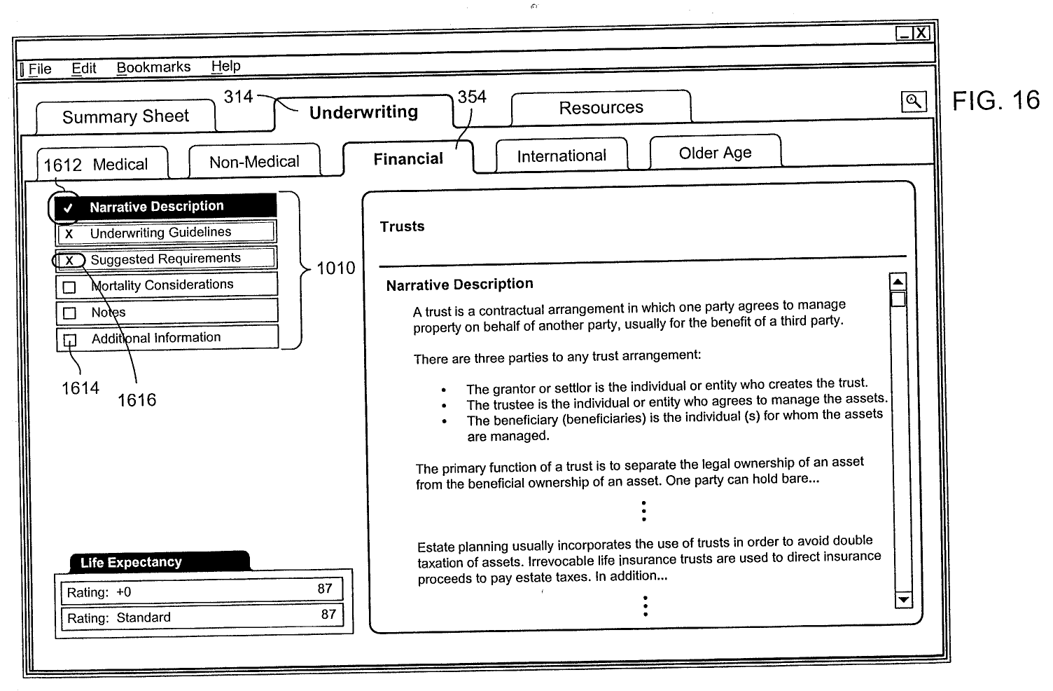

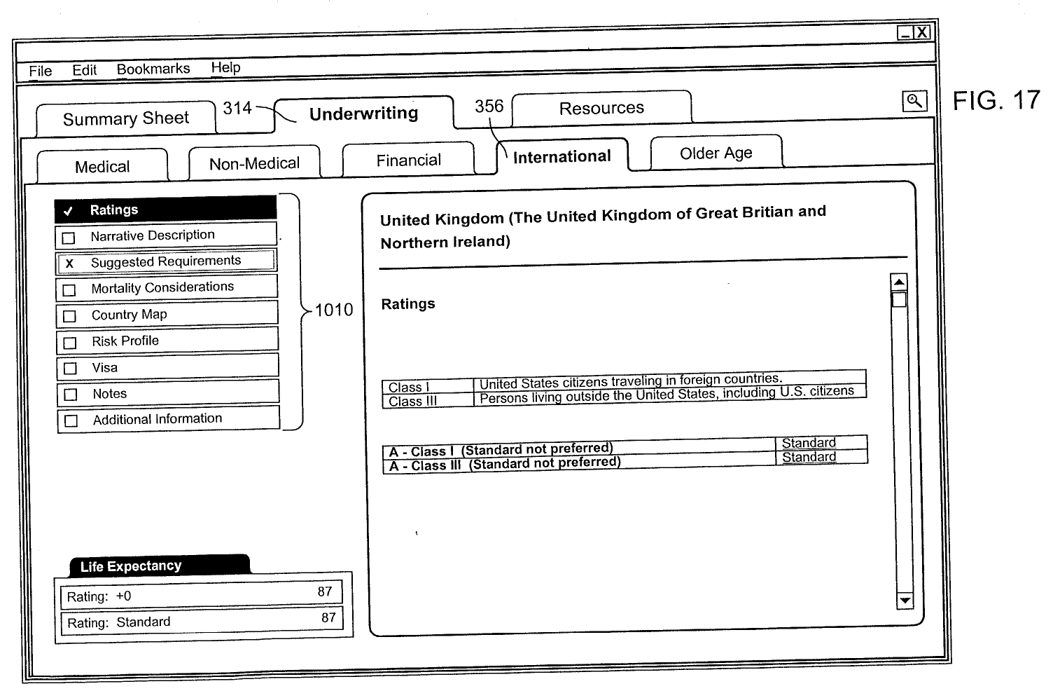

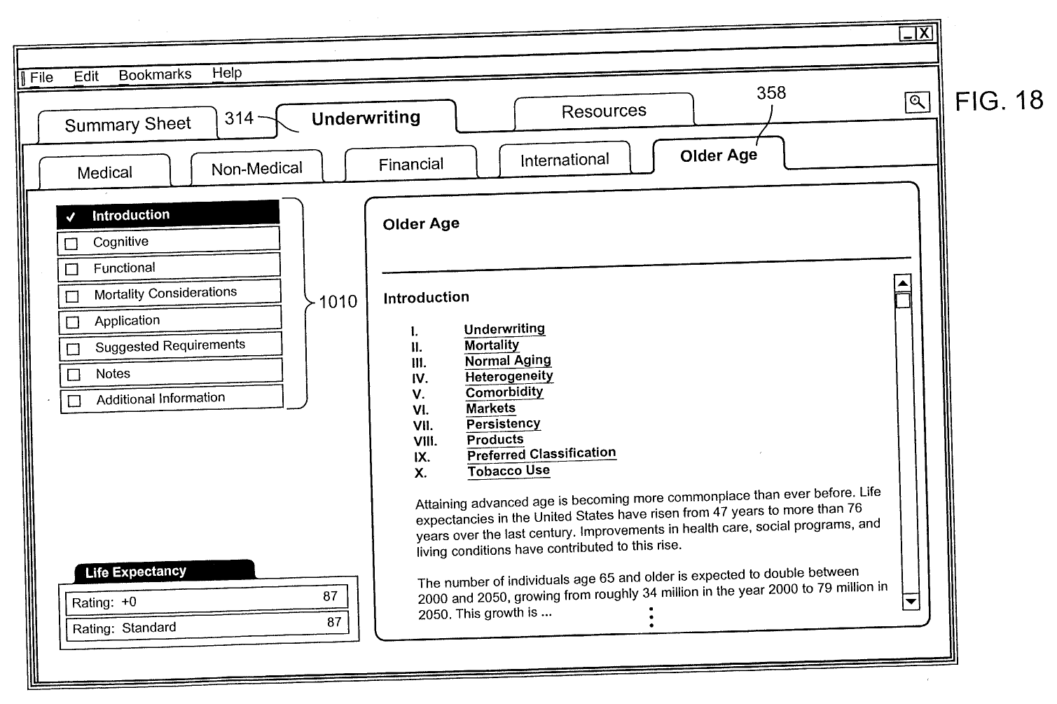

In FIG. 16 there is illustrated an exemplary display under the Financial Sub Tab 354, with the topic (condition) of “trusts” selected and displayed. In FIG. 17, there is illustrated an exemplary display under the International Sub Tab 356, with the topic (condition) of “United Kingdom” selected and displayed. In FIG. 18, there is illustrated an exemplary display under the Older Age Sub Tab 358, with the topic (condition) of “Introduction” selected and displayed.

It should be noted that for each of the underwriting sub tabs 352 through 358, the kind of information that should be available to the underwriter may vary in scope and content. This is somewhat evident by the sub options menu 1010 for each sub tab. For example, for the Non-Medical Sub tab 352 there will need to be categories of information analogous to that in the Medical Sub Tab 350, since, e.g., certain avocations such as the illustrated boxing, will have mortality risks and the underwriter will need to assign ratings and consider the activity much in the same way as a medical condition. Other sub tabs, such as the Financial Sub Tab 354, may be merely informational (e.g., providing information about potential purposes of an insurance policy sought), and the types of information used by the underwriter (and reflected in the sub options menu 1010) may be different or more limited.

As also illustrated in FIG. 16 (and elsewhere), the highlighted sub-option (“Narrative Description” in FIG. 16) is the sub-option to which information is displayed, and is seen with an associated check mark 1612 (“√”). Other available (but not selected) sub-options have an associated check box 1614, and unavailable sub-options (titles are provided, but information is not available or has not yet been loaded into conditions database 122) are shown with an associated “x” 1616.

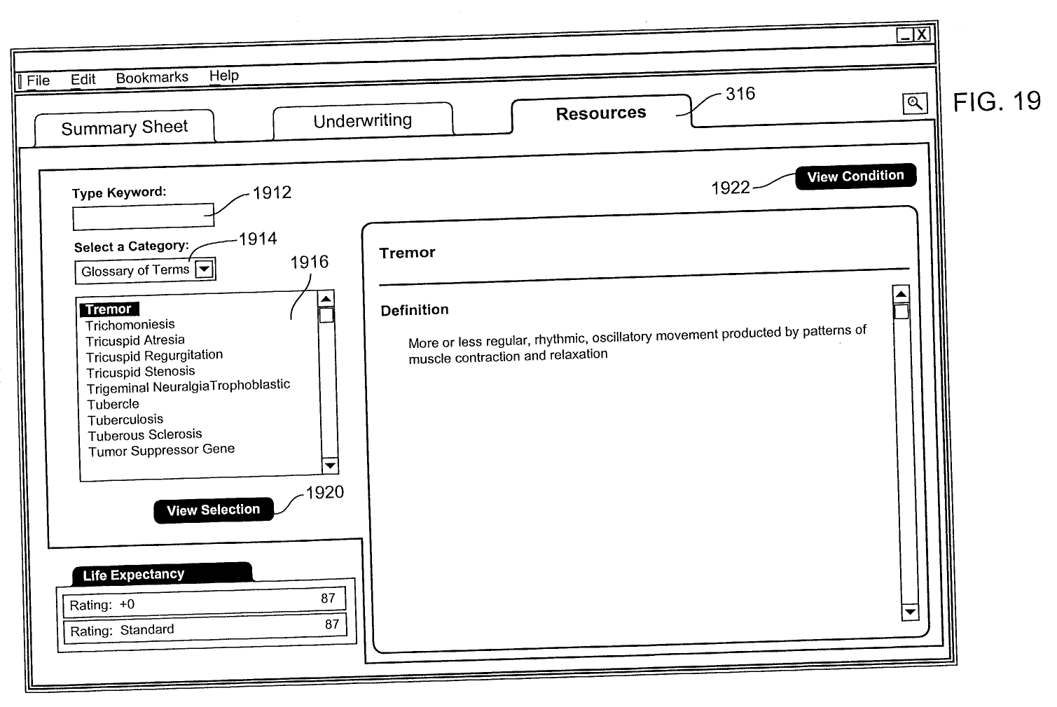

Turning now to FIG. 19, there is illustrated the Resources Super Tab 316. As mentioned earlier, the Resources Super Tab is used as an information source for the underwriter. In the screen illustrated in FIG. 19, the underwriter has chosen information on a “tremor” condition. The Resources Super Tab screen provides (as seen in FIG. 19) fields for locating information, such as a “keyword” field 1912 and a category field 1914, and a window 1916 for displaying an alphabetically arranged index of information topics in response to an entry in the keyword field 1912. A view selection button 1920 is selected when the user wants information on a term highlighted in the box 1916, and if the selected term is for an identified condition, a “View Condition” button 1922 appears—which if selected will lead the underwriter back to the appropriate condition screen under the Underwriting Super Tab 314 (such as the screen illustrated in FIG. 10 for a “tremor” condition).

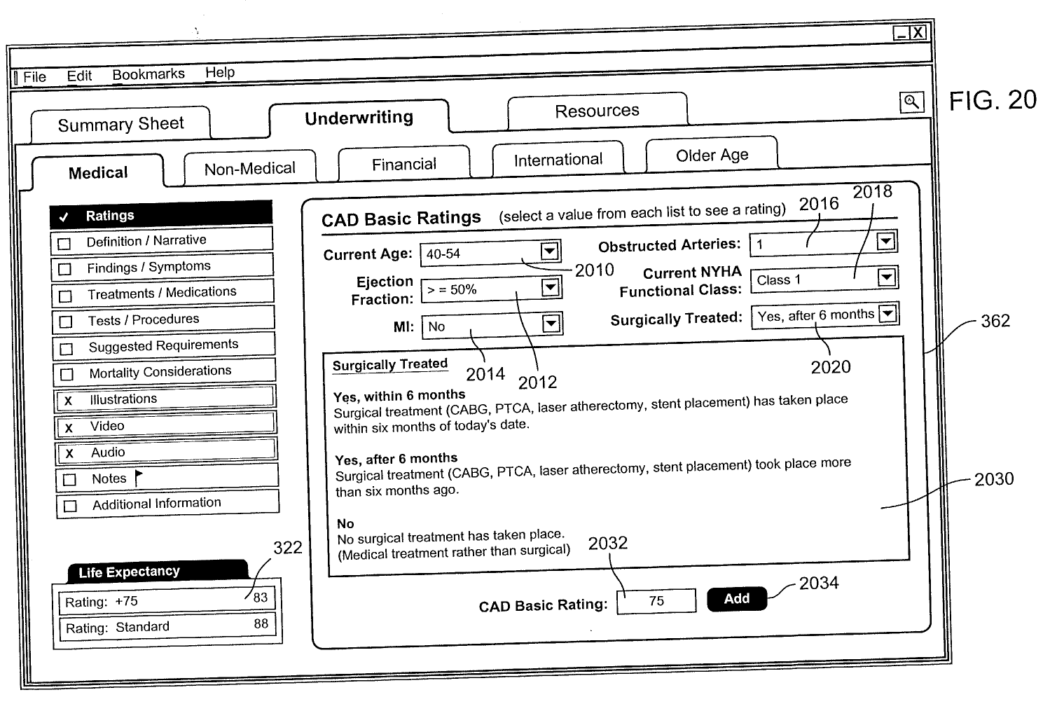

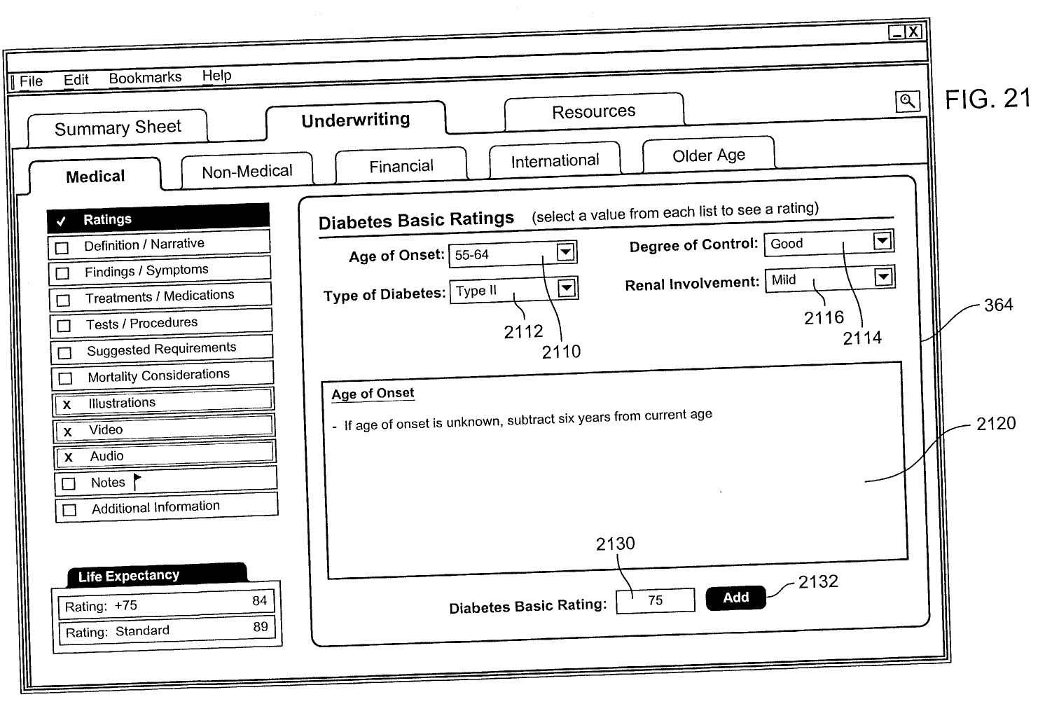

FIGS. 20 and 21 show screens for the CAD (coronary artery disease) profile 362 and the diabetes mellitus profile 364 that were mentioned earlier in conjunction with FIG. 3. These two specific conditions are examples of conditions where ratings can be much more difficult to determine because of multiple factors that each need to be considered. The CAD profile in FIG. 20 is seen as requesting data for six factors in fields 2010, 2012, 2014, 2016, 2018 and 2020. The six factors and the values that can be selected for each are shown in the following Table III:

TABLE III

| CAD Factors | Selectable Values |
|---|---|
| Current Age | 1) 30-39 2) 40-54 3) 55-69 4) 70+ |
| No. of obstructed arteries | 1) 0 2) 1 3) 2 4) 3 5) Unknown—map |
| | unknown to 1 vessel |
| Ejection Fraction/LV Function | 1) EF >= 50% 2) EF 41-49% 3) EF |
| | 36-40% 4) EF <= 35% |
| | 5) Unknown—map unknown to |
| | EF 41-49% |
| Surgically Treated (PTCA, CABG, | 1) Yes within 6 months 2) Yes |
| Stent) | after 6 months postop 3) No—map |
| | to medical treatment rather than |
| | surgical treatment |
| MI (Myocardial Infarction) | 1) Yes within 6 months 2) Yes |
| | after 6 months 3) Yes Multiple |
| | 4) No 5) Unknown—map to no |
| Current NYHA (New York Heart | 1) Class 1 2) Class II 3) Class III |
| Association) Functional Class | 4) Class IV 5) Unknown—map |
| | unknown to Class II |

As fields 2010, 2012, 2014, 2016, 2018 and 2020 are each accessed for entry, a window 2030 may provide background information on the values that may be selected for that field.

Upon entry of data in all of the fields 2010 through 2020, a rating (taken from industry standard information) is automatically retrieved from a ratings table (stored in conditions database 122) and displayed as a CAD basic rating 2032. That rating is also transferred to the Conditions Summary Sub Tab 338 when an “Add” button 2034 is selected. Note that the Life Expectancy Sub Tab 322 is displayed on the screen and automatically reflects the change in life expectancy when the rating is transferred to the Condition Summary Sub Tab 338.

In FIG. 21 there is shown a similar screen for the diabetes profile 364. This profile is seen as requesting data for four factors in fields 2110, 2112, 2114 and 2116, with the factors and values to be selected illustrated in the following Table IV:

TABLE IV

| Diabetes Factors | Selectable Values |
|---|---|
| Age of Onset | 1) 0-14 2) 15-24 3) 25-34 4) 35-44 |
| | 5) 45-54 6) 55-64 7) 65+ |
| Type of Diabetes | 1) Type I 2) Type II |
| Degree of Control | 1) Excellent 2) Good 3) Fair 4) Poor |
| (e.g., Hemoglobin A1c test) | 5) Uncontrolled |
| Renal Involvement | 1) None 2) Mild 3) Moderate (4) Significant |
| (e.g., Proteinuria level test) | 5) Severe |

As with the CAD profile in FIG. 20, a window 2120 may provide background information on the values that may be selected for each field as that field is accessed for entry of values or data. Upon entry of data in all of the fields 2110 through 2116, a rating is automatically retrieved from a ratings table (stored in conditions database 122) and displayed as a diabetes basic rating 2130. That rating is then transferred to the Conditions Summary Sub Tab 338 when an “Add” button 2132 is selected. Note that the Life Expectancy Sub Tab 322 is displayed on the screen and automatically reflects the change in life expectancy when the rating is transferred to the Condition Summary Sub Tab 338.

The ratings tables stored in conditions database 122 and used by the CAD profile 362 and the diabetes profile 364 are taken from public information sources well known to these skilled in the art, e.g., Medical Selection of Life Risks, 4th Edition, by R. D. C. Brackenridge, M.D. and W. John Elder, M.D. (New York: Stockton Press, 1998).

As an example, a table (and notes programmed with the table) for retrieving a CAD profile rating for an applicant having a current age of 40-54 (such as for the applicant in the CAD profile screen seen in FIG. 20) is illustrated in Appendix B. A table for retrieving a diabetes profile rating for an applicant having an onset age of 55-64 (such as the applicant in the diabetes profile screen seen in FIG. 21) is illustrated in Appendix C.

Further, it should be appreciated that the profiles seen in FIGS. 20 and 21 have factors used for underwriting when coronary artery disease and diabetes are relatively free of complications. As will be understood by those skilled in the art, more complex profiles (and ratings tables) may be used for considering additional factors when there are such complications.

While a detailed description of presently preferred embodiments of the invention have been given above, various alternatives, modifications, and equivalents will be apparent to those skilled in the art without varying from the spirit of the invention. For example, although the system 100 is illustrated for use in underwriting life insurance, other risk underwriting (e.g., health insurance) can benefit from the invention. Therefore, the above description should not be taken as limiting the scope of the invention, which is defined by the appended claims.

[image]

[image]

[image]

What is claimed is:

1. A computer system for use by an underwriter in underwriting insurance, comprising:
a processor;
an input device;
a display device; and
a storage device for storing information concerning the insurance applicant;
wherein the processor is programmed to provide a graphical user interface on the display device for use by the underwriter, the graphical user interface including:
one or more underwriting screens where a rating is displayed for a condition identified by the underwriter; and
a summary screen for displaying a plurality of information categories concerning the applicant, the information categories including a condition summary which automatically captures and displays individual ratings for conditions selected by the underwriter on one or more of the underwriting screens and a total for all the individual ratings; and
wherein the processor is programmed for the underwriter to manually adjust both the individual ratings displayed on the condition summary and the total of ratings displayed on the condition summary in order to reflect the judgment of the underwriter as to the appropriate total rating to be assigned to the applicant.

2. The system of claim 1, wherein the system is used for underwriting life insurance and wherein the processor is programmed to compute the life expectancy of the applicant using a life expectancy table stored in the storage device, wherein the information categories displayed on the summary screen further include a life expectancy for the applicant, the life expectancy displayed in proximity to the condition summary so that the underwriter can observe changes in life expectancy as individual ratings and the total rating are manually adjusted by the underwriter.

3. The system of claim 2, wherein the processor is programmed to compute the life expectancy based on the total rating displayed in the condition summary.

4. The system of claim 3, wherein the life expectancy table stores life expectancy data representing the life expectancy of the applicant, the life expectancy determined by the current age of the applicant and one of a plurality of different ratings associated with that current age.

5. The system of claim 4, wherein the life expectancy data represents, for each of the different ratings, the remaining number of years that the applicant would be expected to live.

6. The system of claim 5 wherein the current age of the applicant is stored in the storage device, and wherein the processor is programmed to retrieve the stored current age, to retrieve the life expectancy data from the life expectancy table, and to combine the retrieved current age and the retrieved life expectancy data in order to provide the age at which the applicant is expected to die.

7. The system of claim 2, wherein the underwriting screens include a profile screen for entering profile information on the applicant concerning a complex medical condition, wherein the profile information includes a plurality of factors, wherein the underwriter is prompted by the profile screen to enter data values for each factor, and wherein after entry of profile information, a rating for the complex medical condition is automatically displayed.

8. The system of claim 7, wherein the complex medical condition is coronary artery disease.

9. The system of claim 7, wherein the complex medical condition is diabetes.

10. The system of claim 2, wherein the life expectancy is displayed simultaneously with the condition summary.

11. The system of claim 10, wherein the life expectancy and the condition summary are displayed simultaneously with another, different information category.

12. A graphical user interface for use by an underwriter in underwriting insurance for an insurance applicant, comprising:
a condition summary screen wherein a rating is displayed for a condition identified by the underwriter and wherein the rating may be manually adjusted by the underwriter; and
a life expectancy screen that reflects the life expectancy of the applicant and that is displayed with the condition summary screen, the life expectancy based on both the age of the applicant and the rating displayed on the condition summary screen, so that as the rating on the condition summary screen is manually adjusted by the underwriter, any corresponding change in life expectancy is displayed on the life expectancy screen, thereby permitting the underwriter to determine, from the life expectancy screen, the impact of any rating adjustment on life expectancy of the applicant.

13. The graphical user interface of claim 12, wherein the condition summary screen and the life expectancy screen are displayed simultaneously.

14. A graphical user interface for use by an underwriter in underwriting life insurance for an insurance applicant, comprising:
an underwriting screen wherein a rating is displayed for a condition identified by the underwriter; and
a summary screen for displaying a plurality of information categories concerning the insurance applicant, the information categories including:
a condition summary for displaying one or more conditions selected by the underwriter from the underwriting screen and a rating associated with the conditions, wherein the rating displayed in the condition summary may be manually adjusted by the underwriter; and
a life expectancy reflecting the life expectancy of the applicant, the life expectancy based on the age of the applicant and the rating displayed on the condition summary, so that as the rating on the condition summary is manually adjusted by the underwriter, any corresponding change in life expectancy is displayed, thereby permitting the underwriter to determine from the summary screen the impact of any rating adjustment on the life expectancy of the applicant.

15. The graphical user interface of claim 14, wherein the condition summary displays both individual ratings for conditions selected from the underwriting screen and a total of the individual ratings, and wherein the underwriter may adjust both individual ratings and the total rating.

16. The graphical user interface of claim 14, wherein the information categories further include:
personal information identifying the applicant; and
information resulting from a medical examination of the applicant.

17. The graphical user interface of claim 16, wherein the information categories further include:
insurance policy information relating to characteristics of the insurance being applied for by the applicant.

18. The graphical user interface of claim 16, wherein the information categories further include:
medical lab testing results.

19. The graphical user interface of claim 16, wherein the information categories further include:
overall assessment information entered by the underwriter.

20. The graphical user interface of claim 15, wherein the underwriting screen displays a description of a medical condition selected by the underwriter and a plurality of different ratings each reflecting a different characteristic of the medical condition, wherein the underwriter may select one of the different ratings, and wherein the selected rating is automatically displayed in the condition summary and included in the total rating displayed in the condition summary.

21. The graphical user interface of claim 14, further including hypertext links to the Internet in order to provide further information on conditions relevant in underwriting life insurance.

22. The graphical user interface of claim 14, wherein the underwriting screen further includes a profile sub-screen for entering profile information on the applicant concerning a specific, complex medical condition, wherein the information is in a plurality of categories, wherein the underwriter is prompted by the profile sub-screen to enter each category of information, and wherein after entry of information, a rating for the complex medical condition is determined and automatically provided for display on the condition summary.

23. The graphical user interface of claim 22, wherein the complex medical condition is coronary artery disease (CAD).

24. The graphical user interface of claim 22, wherein the complex medical condition is diabetes.

25. The graphical user interface of claim 14, wherein the underwriting screen and summary screen are displayed as super tabs, wherein the information categories are displayed as sub tabs on the summary screen, and wherein an information category may be selected to change from an abbreviated display to an expanded display.

26. The graphical user interface of claim 25, wherein data may be entered in the expanded display.

27. A method for use by an underwriter in underwriting insurance for an insurance applicant, the method comprising:
providing a graphical user interface, the graphical user interface comprising:
a condition screen wherein a rating is displayed for a condition identified by the underwriter and wherein the rating may be manually adjusted by the underwriter; and
a life expectancy screen that reflects the life expectancy of the applicant and that is displayed with the condition screen, the life expectancy based on both the age of the applicant and the rating displayed on the condition screen, so that as the rating on the condition screen is manually adjusted by the underwriter, any corresponding change in life expectancy is displayed on the life expectancy screen, thereby permitting the underwriter to determine, from the life expectancy screen, the impact of any rating adjustment on life expectancy of the applicant.

28. A computer system for use by an underwriter in underwriting insurance, comprising:
processor means;
input means;
display means; and
storage means for storing information concerning the insurance applicant;
wherein the processor means is programmed to provide a graphical user interface on the display means for use by the underwriter, the graphical use interface including:
one or more underwriting screens where a rating is displayed for a condition identified by the underwriter; and
a summary screen for displaying a plurality of information categories concerning the applicant, the information categories including a condition summary which automatically captures and displays individual ratings for conditions selected by the underwriter on one or more of the underwriting screens and a total for all the individual ratings; and
wherein the processor means is programmed for the underwriter to manually adjust both the individual ratings displayed on the summary screen and the total of ratings displayed on the summary screen in order to reflect the judgment of the underwriter as to the appropriate total rating to be assigned to the applicant.
